(19) United States
(12) Patent Application Publication
(10) Pub. No.: US 2015/0014949 A1
(43) Pub. Date: Jan. 15, 2015

(54) Carrying Device Attachment

(71) Applicant: Rick Terrell Dittman, Tenino, WA (US)

(72) Inventor: Rick Terrell Dittman, Tenino, WA (US)

(21) Appl. No.: 14/247,044

(22) Filed: Apr. 7, 2014

Related U.S. Application Data
(60) Provisional application No. 61/809,744, filed on Apr. 8, 2013.

(51) Int. Cl. A45C 13/14; B62B 5/00; B62B 3/04; A45C 5/03; A45C 5/14

(52) U.S. Cl. CPC A45C 13/14; A45C 5/03; A45C 5/14; B62B 3/04; B62B 5/00
USPC 280/47.17

(57) ABSTRACT

Embodiments are disclosed that relate to attaching carrying devices to one another for convenient transport. For example, one disclosed embodiment provides a system comprising a first carrying device and a second carrying device. A catch is disposed on an anterior surface of the first carrying device, and a receiver is disposed on a posterior surface of the second carrying device. The catch is configured to releasably attach to the receiver to thereby connect the first carrying device to the second carrying device.

### CROSS-REFERENCE TO RELATED APPLICATION

This application claims priority to U.S. Provisional Patent Application No. 61/809,744, filed Apr. 8, 2013, entitled “Carrying Device Attachment,” the entire contents of which are hereby incorporated by reference for all purposes.

### BACKGROUND

Carrying devices, such as luggage, may hold various objects for storage and/or transport. Individuals may handle such carrying devices during travel. In some scenarios, however, the number and/or weight of carrying devices may be difficult or prohibitive to handle during a trip, particularly for cases in which luggage is transported via wheels and manipulated with handles.

### SUMMARY

Embodiments are disclosed that relate to attaching carrying devices to one another for convenient transport. For example, one disclosed embodiment provides a system comprising a first carrying device and a second carrying device. A catch is disposed on an anterior surface of the first carrying device, and a receiver is disposed on a posterior surface of the second carrying device. The catch is configured to releasably attach to the receiver to thereby connect the first carrying device to the second carrying device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows an example scenario in which two carrying devices are positioned for attachment to each other.

FIG. 2 schematically shows an example scenario of rotating the carrying devices of FIG. 1 for attachment to each other.

FIGS. 3A and 3B schematically show an example state in which the carrying devices of FIG. 1 are attached to each other.

FIGS. 4A and 4B schematically show an example of a catch in accordance with an embodiment of the present disclosure.

FIGS. 5A and 5B schematically show an example of a receiver in accordance with an embodiment of the present disclosure.

FIGS. 6A-15 show various aspects of carrying devices and attachment mechanisms in accordance with the present disclosure.

### DETAILED DESCRIPTION

During travel, individuals may use carrying devices such as luggage to store and transport objects. Frequently, however, individuals may find it difficult or prohibitive to handle such carrying devices due to their weight or number. For example, hauling carrying devices which are manipulated via handles and transported via wheels may require multiple trips. Accordingly, embodiments are disclosed that relate to attaching carrying devices to one another for convenient transport. For example, one disclosed embodiment provides a system comprising a first carrying device and a second carrying device. A catch is disposed on an anterior surface of the first carrying device, and a receiver is disposed on a posterior surface of the second carrying device. The catch is configured to releasably attach to the receiver to thereby connect the first carrying device to the second carrying device. In this way, the first carrying device and the second carrying device may be transported as a single unit.

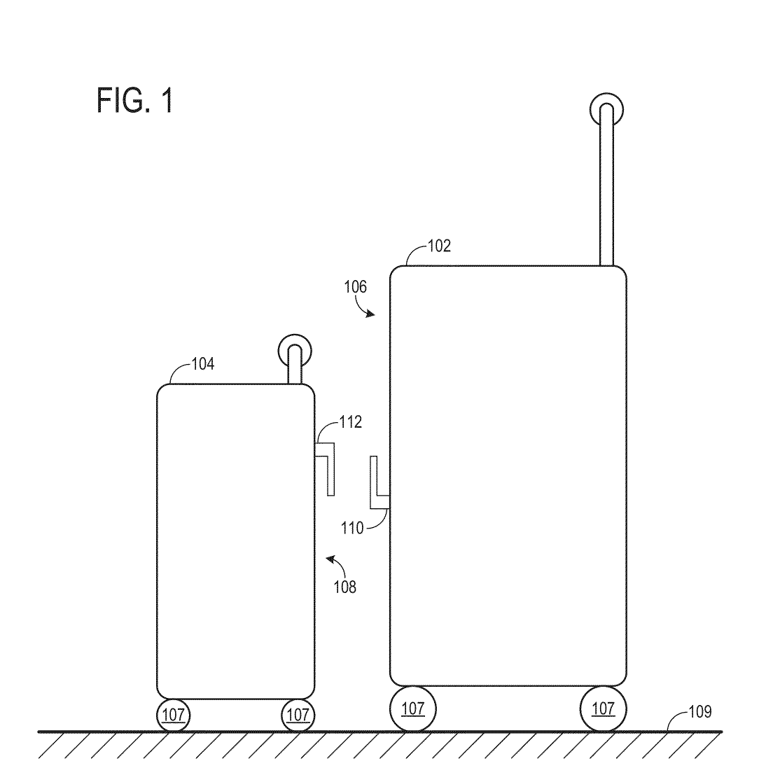

Turning now to FIG. 1, an example scenario in which two carrying devices are positioned for attachment to each other is schematically shown. In this example, a first carrying device 102 is positioned adjacent a second carrying device 104, with an anterior surface 106 of the first carrying device 102 facing in opposition to a posterior surface 108 of the second carrying device. Anterior surface 106 may be parallel to posterior surface 108, for example. First and second carrying devices 102 and 104 may be luggage devices configured to hold various objects for storage and transport, and may be moved by imparting motion to one or more wheels 107 to thereby roll the carrying devices across a surface 109, for example. It will be appreciated, however, that other types of carrying devices may be used without departing from the scope of this disclosure, including those lacking wheels (e.g., carrying devices having low-friction bottom surfaces or devices capable of levitation above the ground).

First carrying device 102 includes a catch 110 disposed on anterior surface 106, while second carrying device 104 includes a receiver 112 disposed on posterior surface 108. Catch 110 and receiver 112 are in this example mated to each other, such that, when engaged, first carrying device 102 may be securely and releasably attached to second carrying device 104, allowing the carrying devices to be handled and transported as one unit. In some embodiments, catch 110 may be a receiver translated about both a horizontal and vertical axis (e.g., a single part may be used to form a catch and receiver). In other embodiments, catch 110 may differ from receiver 112 in size, dimension, and other aspects, as further described below.

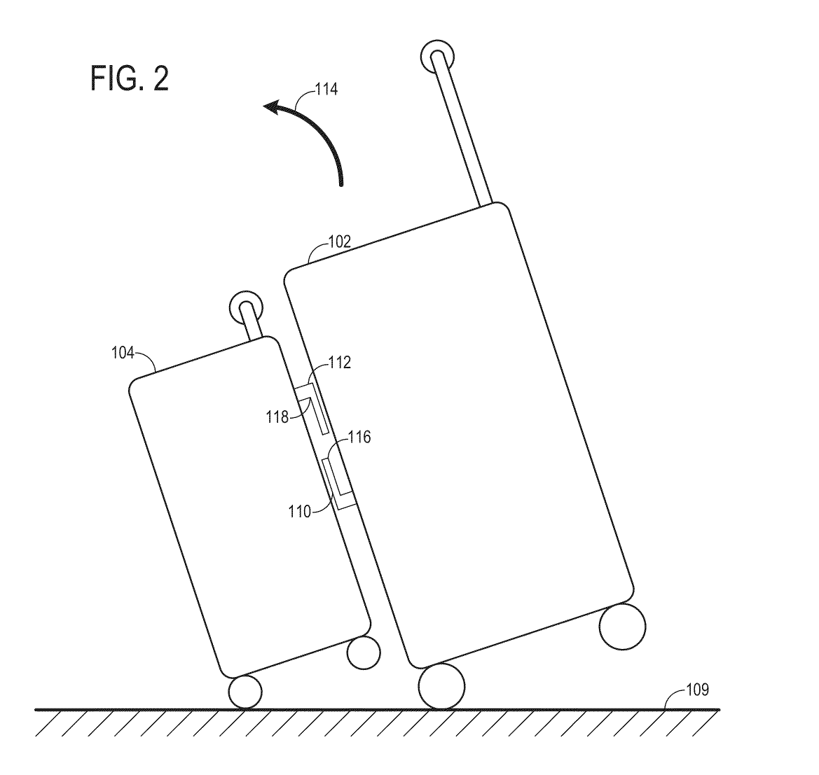

Turning now to FIG. 2, an example scenario is schematically shown in which first and second carrying devices 102 and 104 are rotated to cause catch 110 to engage receiver 112 and thus facilitate attachment of the first and second carrying devices to each other. In particular, a distance between first and second carrying devices 102 and 104 is reduced, and the carrying devices are rotated in a counter-clockwise direction through an angle (e.g., 15°) from surface 109 on which they rest, the rotation represented by an arrow 114. First and second carrying devices 102 and 104, and more particularly catch 110 and receiver 112, are brought into a position in which the catch and receiver may become engaged with each other once the carrying devices are placed in their previous position level with surface 109—e.g., a position in which the carrying devices are substantially parallel with surface 109, as shown in FIG. 1, for example.

It will be appreciated that the degree of rotation of first and second carrying devices 102 and 104 shown in FIG. 2, applied to facilitate attachment of the carrying devices to each other, is exemplary in nature and not intended to be limiting. Such degree of rotation may be adjusted based on the size and/or shape of catch 110 and receiver 112, and may be further varied based on the vertical position of catch 110 and receiver 112 along anterior surface 106 and posterior surface 108, respectively. In other scenarios, the degree of rotation of first carrying device 102 may be reduced compared to the degree of rotation shown in FIG. 2, and may be substantially negligible—e.g., attachment of first and second carrying devices 102 and 104 may be sufficiently completed while the first carrying device remains level with surface 109.

Following the application of an angular separation from surface 109 in which first and second carrying devices 102 and 104 are separated from the surface, the angular separation may be reduced, bringing the carrying devices to a position substantially level with surface 109 as catch 110 is engaged with receiver 112. As the angular separation from surface 109 is reduced, outer corner 116 of catch 110 and an inner corner 118 of receiver 112, as well as their adjacent surfaces, may be brought into contact with each other to attach the catch to the receiver.

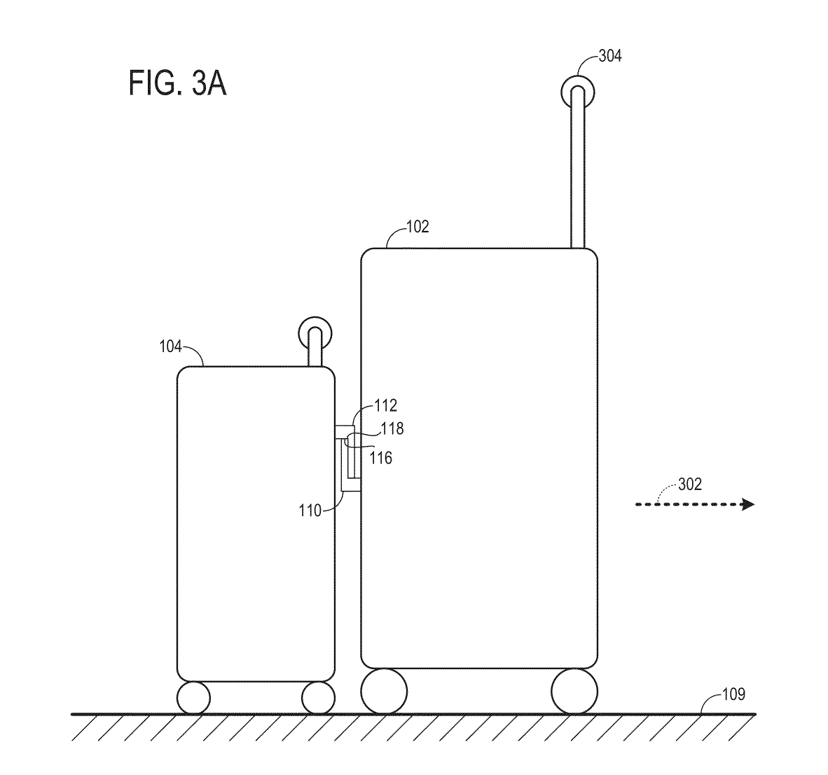

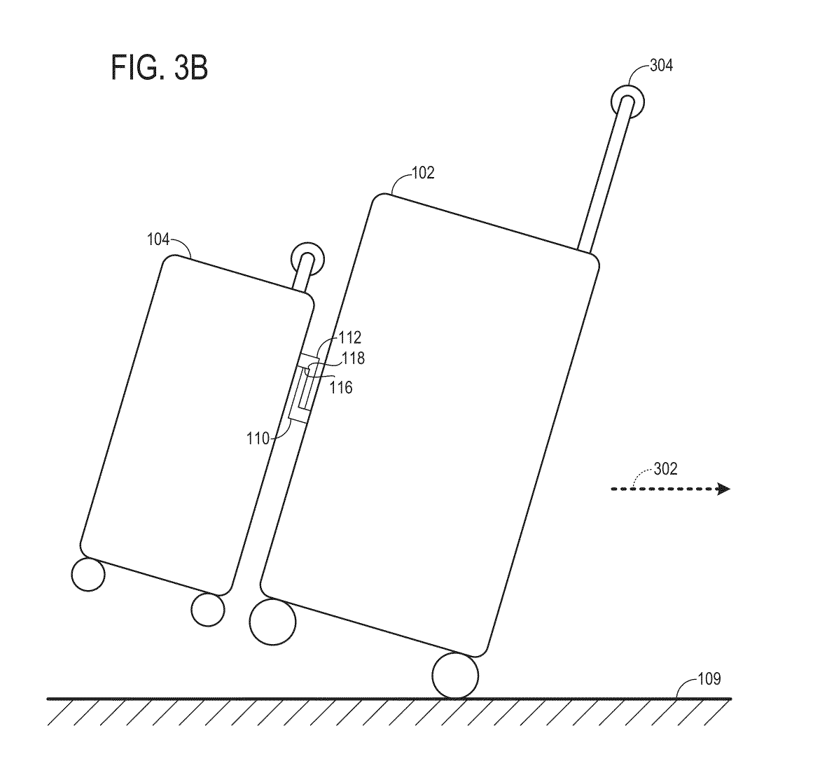

Turning now to FIG. 3A, an example state is shown in which first and second carrying devices 102 and 104 are fully attached to each other. In this example, outer corner 116 and inner corner 118, and their adjacent surfaces, have come into contact with each other, attaching catch 110 to receiver 112 and further attaching first carrying device 102 to second carrying device 104. In this way, both first and second carrying devices 102 and 104 may be transported, for example in a rightward direction 302, by handling (e.g., pulling via handle 304) first carrying device 102. Further, the attachment formed by catch 110 and receiver 112 may accommodate rotation such that first carrying device 102 may be rotated in a clockwise direction, creating an angular separation from surface 109, and transported for example along rightward direction 302, transporting second carrying device 104 as well. FIG. 3B shows such a scenario in which first carrying device 102 has been attached to second carrying device 104 via attachment between catch 110 and receiver 112. First and second carrying devices 102 and 104 have further been rotated in a clockwise direction, and may be transported in this position along rightward direction 302 as a single unit.

It will be appreciated that the attachment between catch 110 and receiver 112 in this embodiment is releasable—e.g., catch 110 may be detached from receiver 112 by substantially reversing the attachment process illustrated in FIGS. 1-3B, allowing first carrying device 102 to be separated from second carrying device 104. Alternatively or additionally, detachment may be carried out by lifting a carrying device in a substantially vertical direction. In the example shown in FIG. 3A, second carrying device 104 may be lifted vertically to carry out detachment from first carrying device 102. Moreover, in some scenarios, attachment of carrying devices to each other (e.g., attachment of second carrying device 104 to first carrying device) may be facilitated by vertically lifting and subsequently lowering a carrying device having a receiver adjacent a carrying device having a catch.

In the examples shown in FIGS. 1-3B, catch 110 and receiver 112 are positioned at a substantially similar height along surfaces of first and second carrying devices 102 and 104, respectively. When fully attached, wheels 107 of first and second carrying devices 102 and 104 may be substantially aligned and level with surface 109, which may improve balance and thus reduce loss of balance (e.g., tipping) as the carrying devices are handled as a single unit. However, in other embodiments catch 110 and receiver 112 may be positioned at unequal heights along carrying device surfaces, in which case the wheels of each carrying device may rest at unequal vertical positions when in a non-rotated state (e.g., wheels of one carrying device may rest above surface 109, while wheels of another carrying device remain in contact with the surface).

It will be further appreciated that the number of carrying devices illustrated in FIGS. 1-3B may be varied without departing from the scope of this disclosure. For example, three or more carrying devices may be attached to one another by disposing one or more catch-receiver pairs on adjacent anterior and posterior surfaces. Attachment between adjacent carrying devices may be carried out in a manner analogous to the method described above with reference to FIGS. 1-3B.

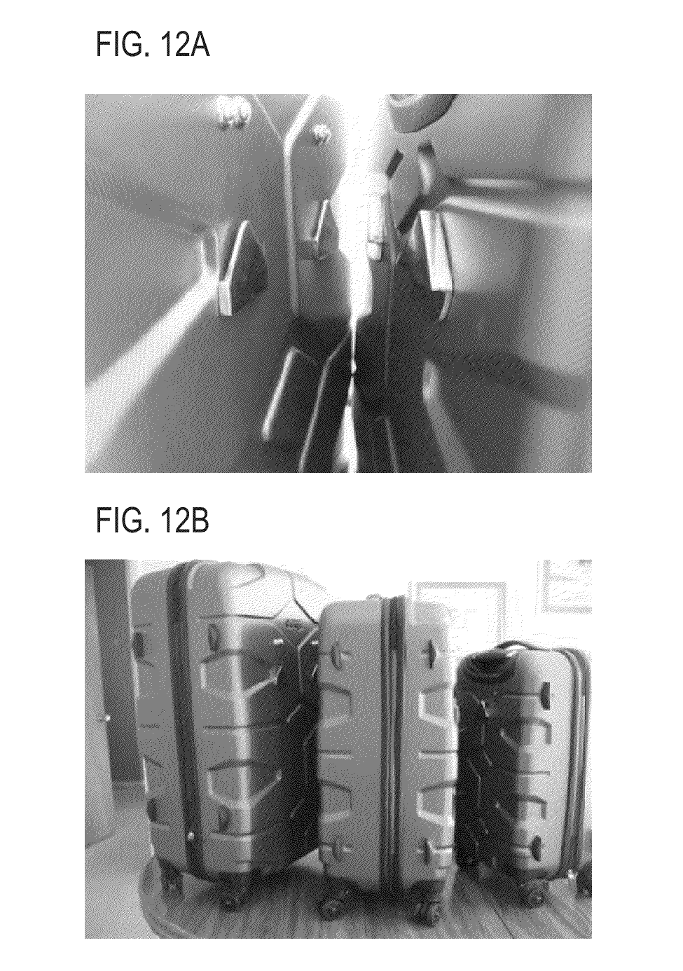

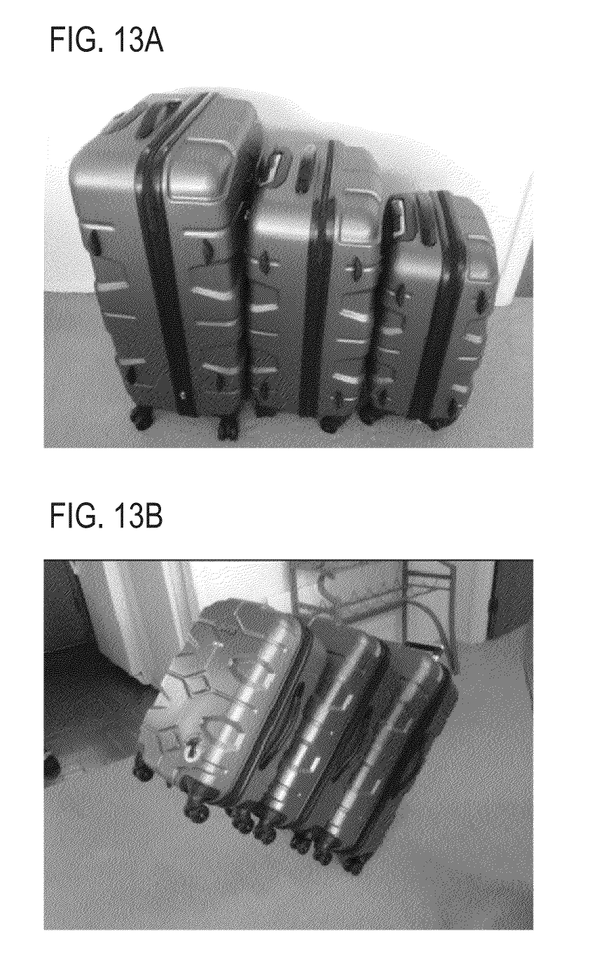

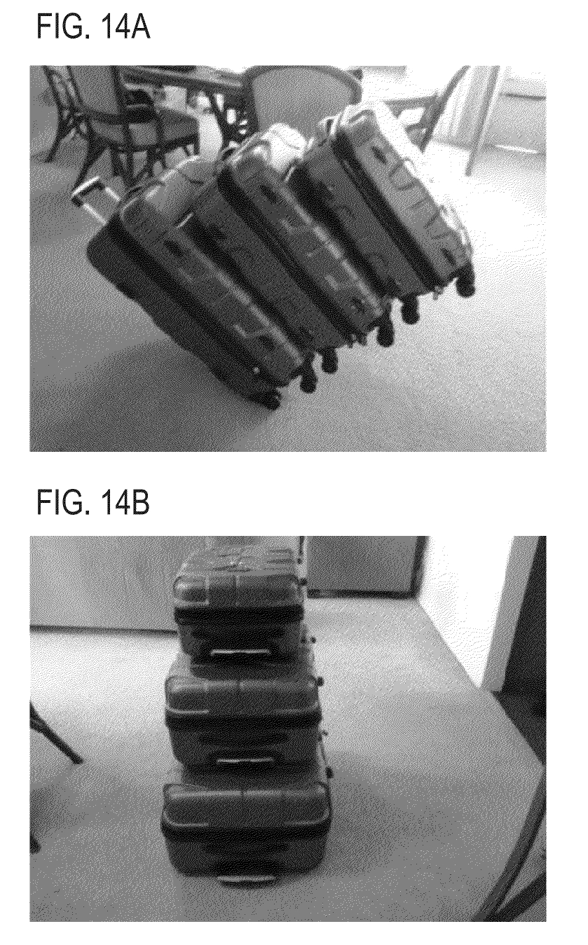

It will also be appreciated that two or more catch-receiver pairs per adjacent anterior-posterior surface may be used to attach adjacent carrying devices to each other, as shown in FIGS. 12A-14B. Use of two or more catch-receiver pairs may strengthen attachment between adjacent carrying devices and enhance carrying device transport in which more than two carrying devices are attached to one another.

Alternative embodiments are possible in which catch 110 may be reflected about a vertical axis and disposed on posterior surface 108 of second carrying device 104, and in which receiver 112 may be reflected about the vertical axis and disposed on anterior surface 106. In this embodiment, first carrying device 102 may be rotated clockwise to create separation from surface 109 and released to cause engagement between catch 110 and receiver 112.

Catch 110 and receiver 112, in addition to other pairs not shown in FIGS. 1-3B, may be attached to respective surfaces (e.g., anterior, posterior) of carrying devices via any suitable method (e.g., glue, screws, etc.). Holes may be bored, for example, in portions of catch 110 and receiver 112 to accommodate screws which may be threaded through the bored holes and into interiors of first and second carrying devices 102 and 104. Alternatively, catch 110 and receiver 112 may be formed integrally with first and second carrying devices 102 and 104. Catch 110 and receiver 112 may be further modified to enhance attachment between each other, for example by selectively magnetizing portions of the catch and receiver.

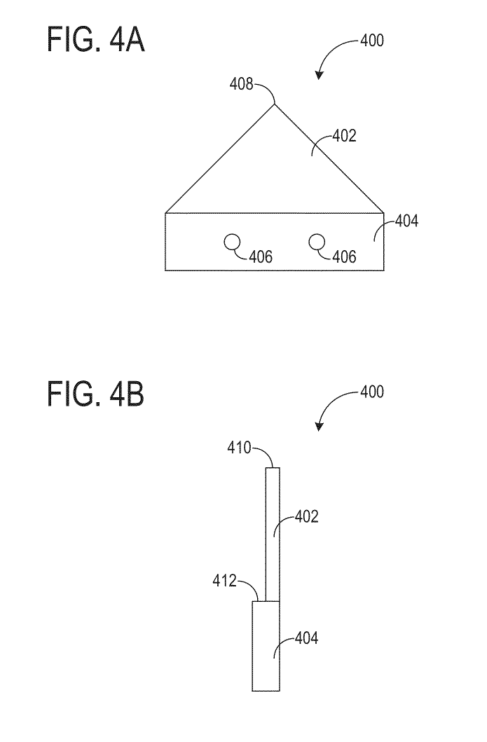

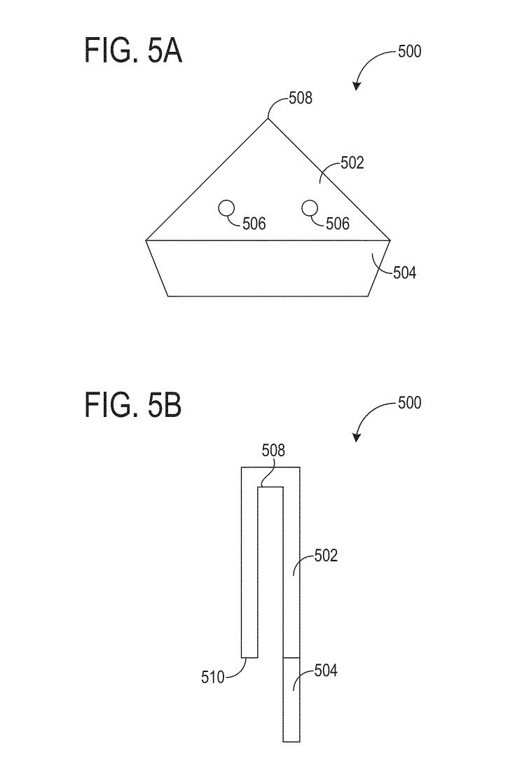

Turning now to FIG. 4A, an example of a catch 400 in accordance with an embodiment of the present disclosure is schematically shown. Catch 400 may be catch 110 shown in FIGS. 1-3B, for example. In this example, catch 400 includes a substantially triangular top 402 and a base 404, which may be affixed to top 402 via any suitable method (e.g., welding), or may formed integrally with the top. Top 402 may be formed as an isosceles triangle, for example, and may be mated and configured to be inserted into a corresponding receiver described in further detail below with reference to FIGS. 5A-5B. Base 404 in this example includes two bore holes 406 which may each accommodate an attachment device such as a screw, as described above. Bore holes 406 may thus be used to affix catch 400 to a carrying device. Corners of catch 400, such as corner 408, may be filleted or rounded. Further, catch 400 may be comprised of any suitable material, such as plastic, fiber glass, copper, steel, alloys, etc., which may be selected based on a desired strength, weight, or other characteristics.

FIG. 4B shows a side view of catch 400, illustrating additional aspects of the catch. In particular, catch 400 may include an outer edge 410 which may come into contact with an inner edge of the receiver shown in FIGS. 5A-5B, as the catch is attached to the receiver. As shown, base 404 may have a greater width than the width of top 402, and may have a base edge 412 which may come into contact with a top edge of the receiver in FIGS. 5A-5B, also as the catch is attached to the receiver.

Turning now to FIG. 5A, an example of a receiver 500 in accordance with an embodiment of the present disclosure is schematically shown. Receiver 500 may be receiver 112 shown in FIGS. 1-3B, for example, and may be mated to catch 400 to facilitate a secure and releasable attachment between the catch and receiver. In this example, receiver 500 includes a top 502 and a base 504, which may be affixed to top 502 via any suitable method (e.g., welding), or may formed integrally with the top. Top includes a pair of bore holes 506, which, like bore holes 406, may each accommodate an attachment device such as a screw. Corners of receiver 500, such as corner 408, may be filleted or rounded. Receiver 500 may be comprised of any suitable material (e.g., plastic, fiber glass, copper, steel, alloys, etc.), which may correspond to the material of which catch 400 is comprised. Top 502 may have a geometry resembling an isosceles triangle, while base 504 may have a geometry resembling an inverted trapezoid with a greater width than the width of base 404 to facilitate secure and releasable attachment between catch 400 and receiver 500. In such an embodiment, receiver 500 may have a geometry resembling that of an irregular pentagon.

FIG. 5B shows a side view of receiver 500, illustrating how top 502 and 504 may have a substantially similar width. Further, receiver 500 may have an inner edge 508 which may come into contact with and abut outer edge 410 of catch 400 as catch 400 is attached to receiver 500. In addition, a top edge 510 may also contact and abut base edge 412 of catch 400 as attachment is carried out. Contact and abutment among such surfaces may facilitate the secure and releasable attachment between catch 400 and receiver 500 as attachment between adjacent carrying devices carried out.

It will be appreciated that the aesthetic appearance (e.g., color, texture, etc.) of catch 400 and receiver 500 may be selected based on various desired characteristics. Catch 400 and receiver 500, for example, may be black or have a smooth, chrome finish applied to their surfaces, which may enhance the appearance of the catch, receiver, and carrying devices to which they are attached. Moreover, virtually any design, pattern, or message may be disposed (e.g., via engraving) on the surfaces of catch 400 and receiver 500, for example personal information including a phone number.

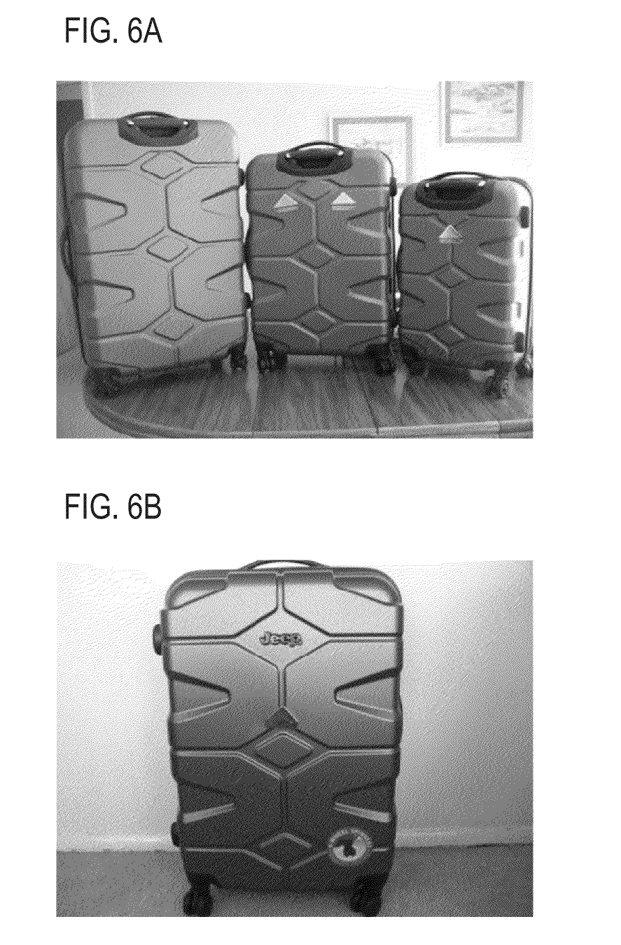

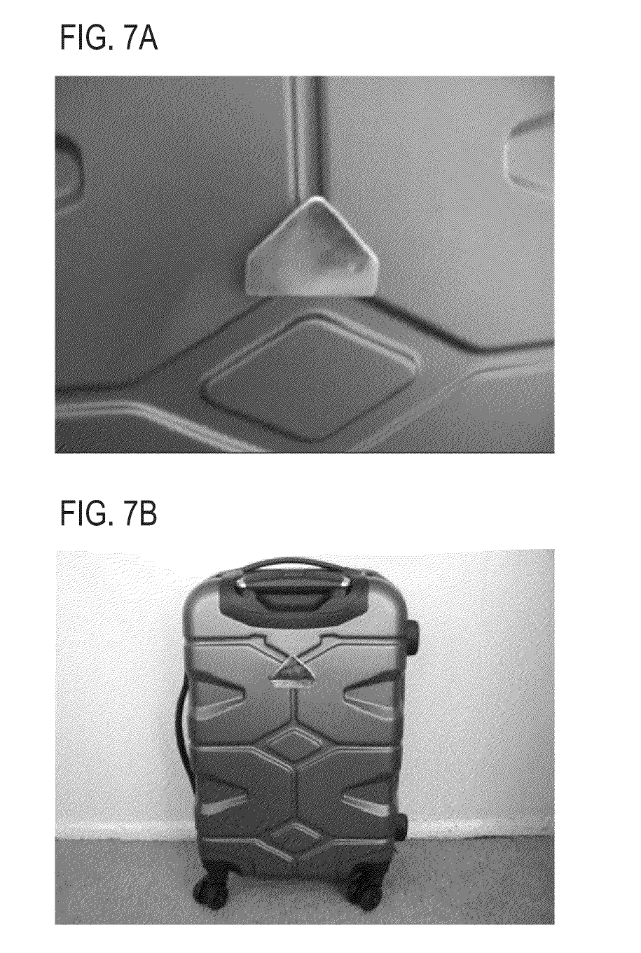

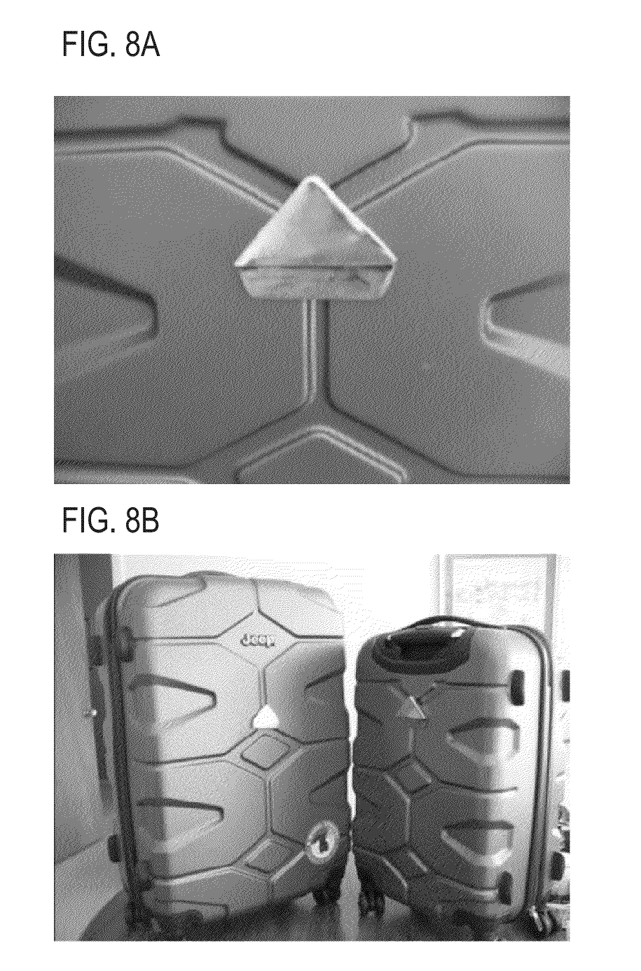

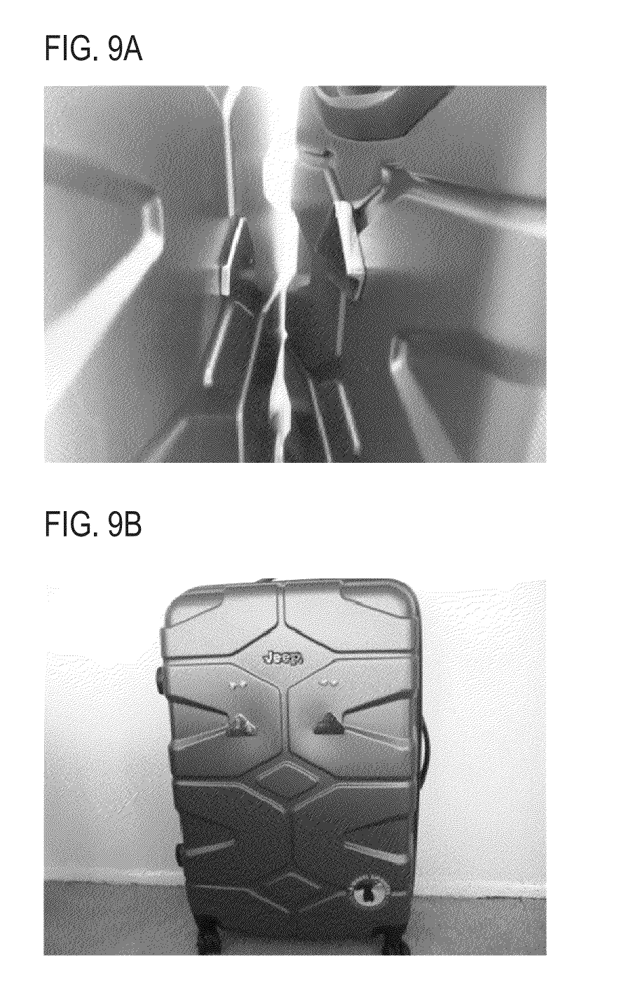

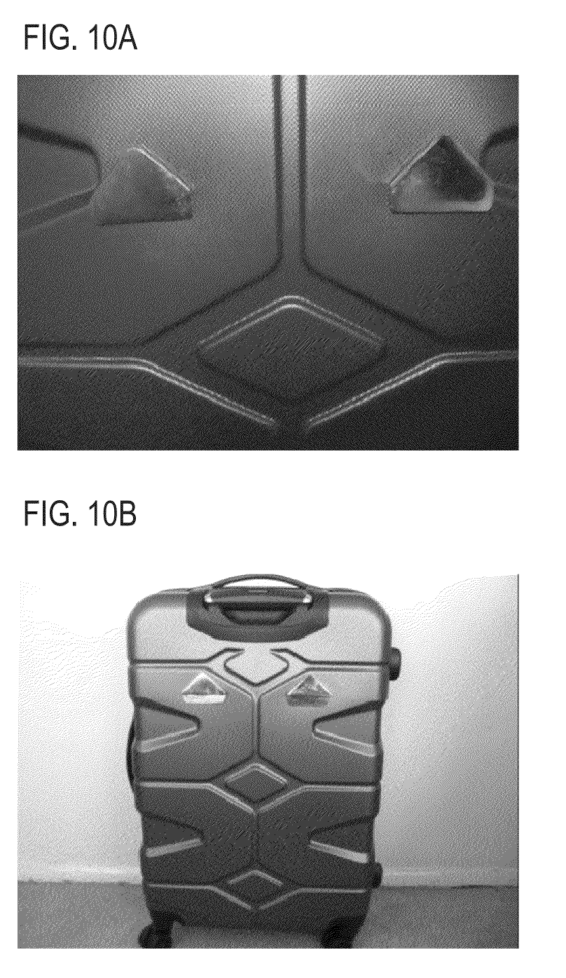

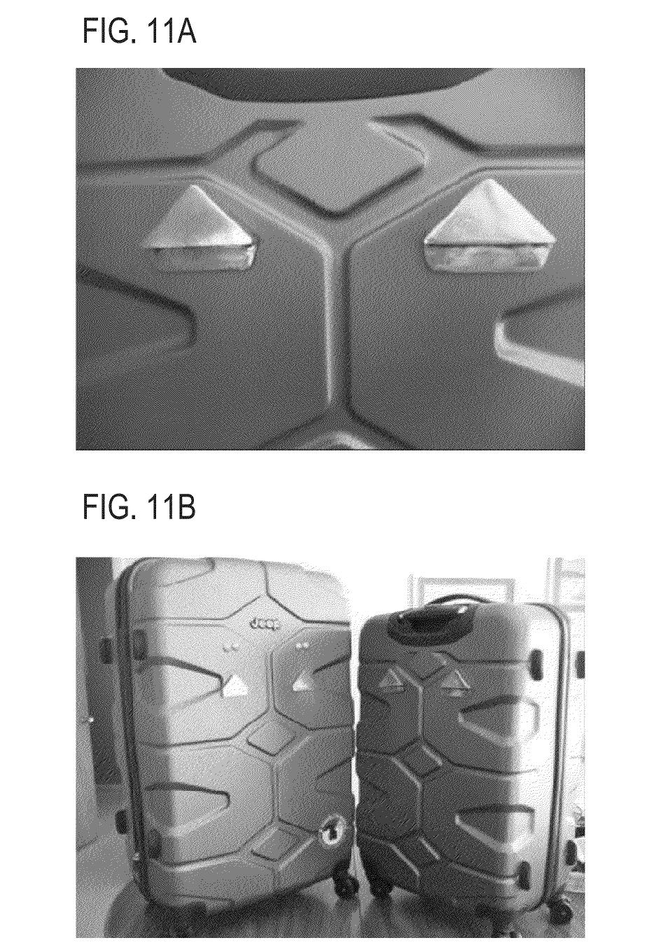

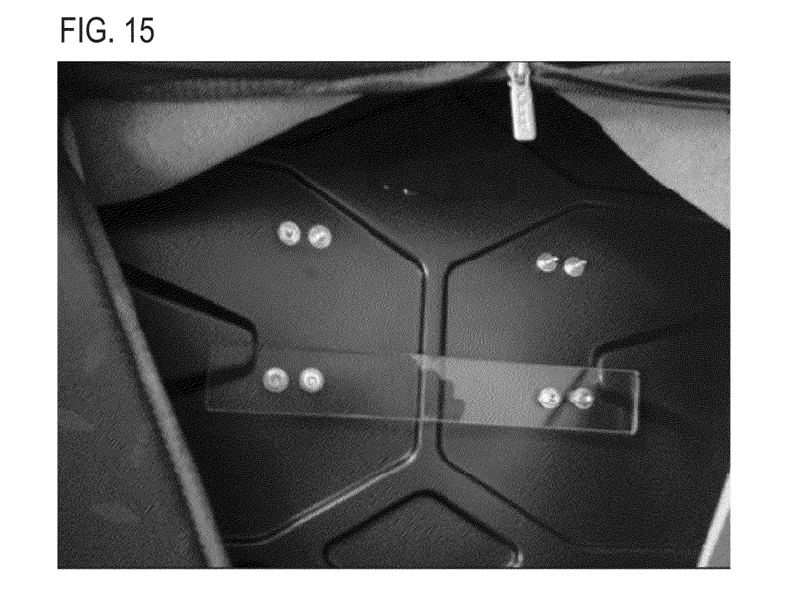

FIGS. 6A-15 show additional non-limiting examples of carrying devices, catches, receivers, and methods of attaching adjacent carrying devices. In particular, FIGS. 6A-8B, 9B, 10A-11B show the disposition of exemplary catches and receivers on carrying devices. FIG. 9A shows an exemplary catch and receiver disposed respectively on a posterior surface and anterior surface of two adjacent carrying devices. In this example, a rightward carrying device may be rotated in a clockwise direction such that the catch is inserted into the receiver as the receiver and respective carrying device is lowered. FIGS. 12A-14B show how two or more catch-receiver pairs may be disposed on adjacent carrying device surfaces and how more than two carrying devices may be attached to one another and transported as a single unit by handling a single carrying device. FIG. 15 shows a non-limiting example of a bracket which may be used to measure and form bore holes (e.g., bore holes 406) in catches and receivers.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A carrying device, comprising:
a storage compartment;
one or more wheels on a bottom of the storage compartment;
a handle connected to the storage compartment; and
a catch on an anterior surface of the storage compartment, the catch configured to cooperatively mate with a corresponding receiver located on a posterior surface of a companion carrying device, such that, when mated, the companion carrying device is securely and releasably attached to the carrying device.
